(19) United States
(12) Patent Application Publication
(10) Pub. No.: US 2007/0019692 A1
(43) Pub. Date: Jan. 25, 2007

(54) Semiconductor laser device and hologram apparatus using the semiconductor laser device

(76) Inventors: Kazuya Kogure, Gunma (JP); Aaron Wegner, Longmont, CO (US); William L. Wilson, Longmont, CO (US)

Correspondence Address: FISH & RICHARDSON P.C., P.O. BOX 1022, MINNEAPOLIS, MN, 55440-1022, US

(21) Appl. No.: 11/204,398

(22) Filed: Aug. 16, 2005

(30) Foreign Application Priority Data
Jul. 19, 2005 (JP) 2005-209256

(51) Int. Cl. H01S 3/04; H01S 3/08

(52) U.S. Cl. 372/34; 372/36; 372/100

(57) ABSTRACT

A semiconductor laser device, with a semiconductor laser element operable to oscillate and output a laser beam, is provided with a heat generation unit operable to generate heat so as to regulate the temperature of the semiconductor laser element, a laser beam splitting unit operable to split a laser beam, oscillated and output from the semiconductor laser element, into first and second beams each forming an optical path different from each other, and a heat generation control unit operable to control the amount of heat generated by the heat generation unit so as to maintain constant a fringe spacing between interference fringes with a plurality of fringes obtained as a result of the interference between the first and second beams.

### CROSS-REFERENCE TO RELATED APPLICATIONS

The present application claims priority upon Japanese Patent Application No. 2005-209256 filed on Jul. 19, 2005, which is herein incorporated by reference.

### BACKGROUND OF THE INVENTION

1. Field of the Invention

The present invention relates to a semiconductor laser device and a hologram apparatus using the semiconductor laser device.

2. Description of the Related Art

The oscillation wavelength of a semiconductor laser element is generally known to vary considerably depending on the temperature. For this reason, an arrangement is proposed, that keeps the temperature of the semiconductor laser element constant to stabilize the oscillation wavelength of the semiconductor laser element.

FIG. 12 illustrates the configuration of a conventional semiconductor laser device provided with an arrangement designed to stabilize the oscillation wavelength.

The conventional semiconductor laser device comprises a semiconductor laser unit 50, with a semiconductor laser element 100, a heater 109 operable to generate heat to regulate the temperature of the semiconductor laser element 100 and a thermistor 110 operable to detect the temperature of the semiconductor laser element 100, integrated in a single housing, a laser drive circuit 122 operable to supply a drive current to the semiconductor laser element 100 and a temperature control circuit 600 operable to control the amount of heat generated by the heater 109 to maintain constant the temperature detected by the thermistor 110.

It is to be noted that the arrangement of the conventional semiconductor laser device as illustrated in FIG. 12 is disclosed, for example, in Japanese Patent Application Laid-open Publication No. 2003-31893.

Incidentally, the arrangement of the conventional semiconductor laser device as illustrated in FIG. 12 does nothing more than keeps the semiconductor laser device temperature constant. For this reason, it cannot be accurately determined whether the oscillation wavelength of the semiconductor laser element is actually stable. Moreover, it cannot be determined whether the semiconductor laser element is oscillating in single mode, an inherently ideal mode. Therefore, it involves difficulty in meeting the recent demand for more stable oscillation wavelength of the semiconductor laser elements with the conventional arrangement.

### SUMMARY OF THE INVENTION

The present invention, whose chief object is to solve the aforementioned problem, has, in a semiconductor laser device with a semiconductor laser element operable to oscillate and output a laser beam, a heat generator that generates heat so as to regulate the semiconductor laser device temperature, a laser beam splitter that splits the laser beam, oscillated and output from the semiconductor laser element, into first and second beams each forming an optical path different from each other, and a heat generation controller that controls the amount of heat generated by the heat generator so as to maintain constant the fringe spacing between interference fringes with a plurality of fringes obtained as a result of the interference between the first and second beams.

The present invention can provide a semiconductor laser device designed to stabilize the wavelength with a simple arrangement and a hologram apparatus using the semiconductor laser device.

### BRIEF DESCRIPTION OF THE DRAWINGS

FIG. 1 illustrates the configuration of a semiconductor laser device according to an embodiment of the present invention;

FIG. 2A illustrates an optical system according to an embodiment of the present invention operable to split the laser beam on the front side, whereas FIG. 2B illustrates an optical system according to an embodiment of the present invention operable to split the laser beam on the back side;

FIG. 3 illustrates the positional relationship between a line CCD according to an embodiment of the present invention and interference fringes;

FIG. 4 illustrates the output waveform of the line CCD according to an embodiment of the present invention;

FIG. 5 illustrates the configuration of the semiconductor laser device according to an embodiment of the present invention;

FIG. 6 is a flowchart illustrating the process flow of a DSP according to an embodiment of the present invention;

FIG. 7 illustrates Fourier spectra according to an embodiment of the present invention;

FIG. 8 schematically illustrates how monomers transform into polymers in a hologram recording medium;

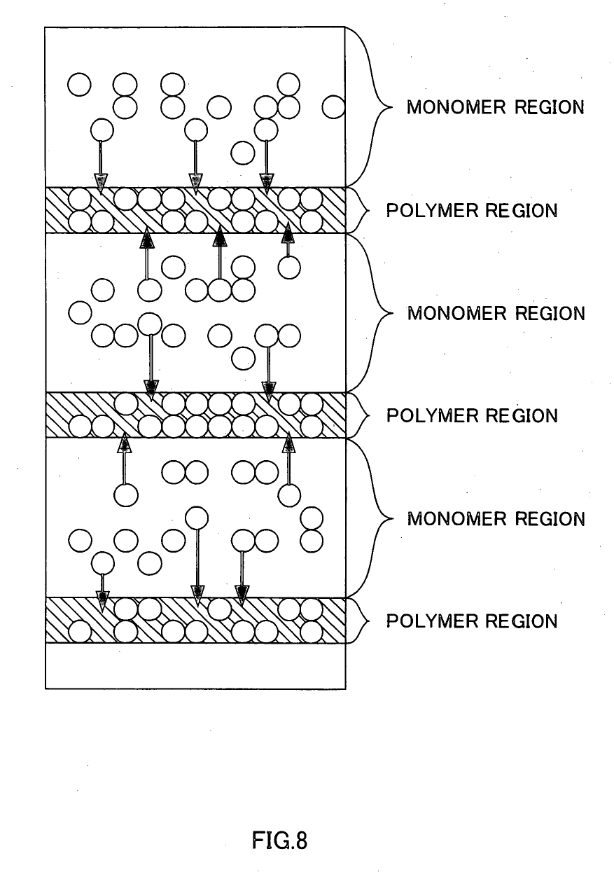

FIG. 9 is an explanatory view of the recording format of the hologram recording medium;

FIG. 10 illustrates the configuration of a hologram apparatus using the semiconductor laser device according to an embodiment of the present invention;

FIG. 11 illustrates the configuration of the semiconductor laser device according to an embodiment of the present invention; and

FIG. 12 illustrates the configuration of a conventional semiconductor laser device.

### DETAILED DESCRIPTION OF THE INVENTION

### First Embodiment

### Heat Generation Controller Configured with Analog Circuitry

===Overall Configuration of the Semiconductor Laser Device===

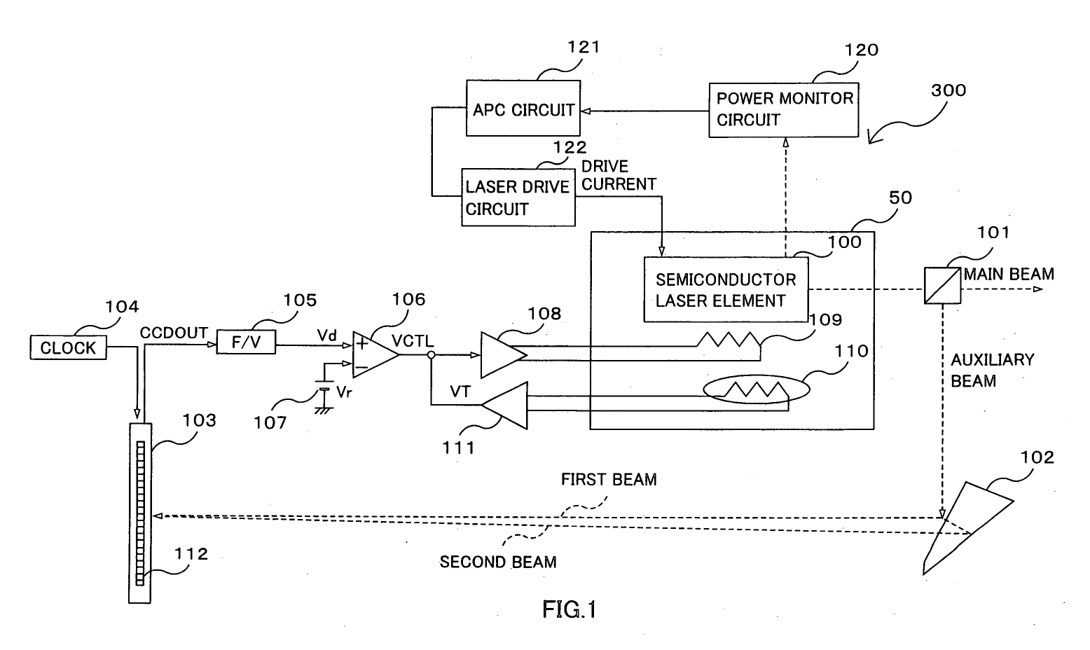

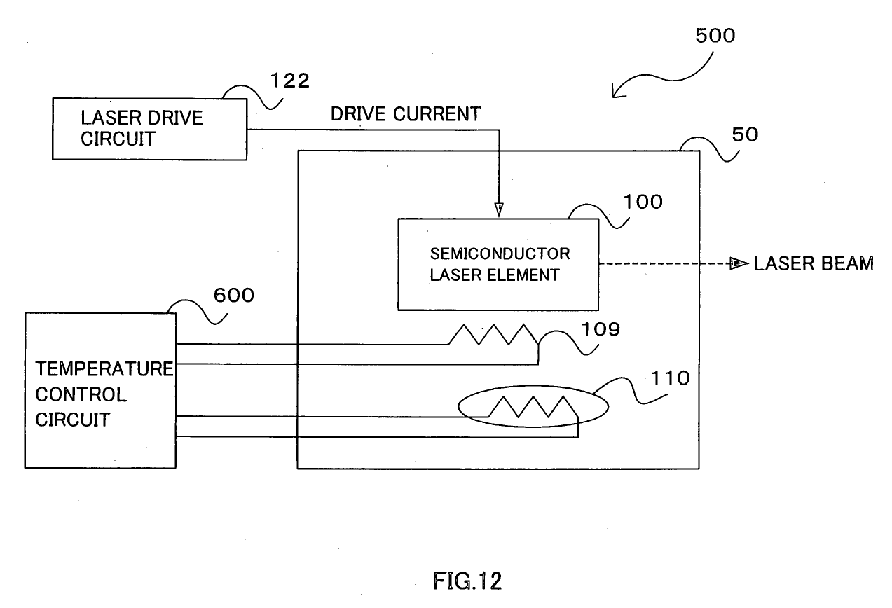

FIG. 1 illustrates the overall configuration of a semiconductor laser device 300 according to a first embodiment of the present invention. It is to be noted that the same reference numerals are used to designate like components as those in a conventional semiconductor laser device 500 illustrated in FIG. 12.

The configuration inside the semiconductor laser unit 50 will be described first.

The semiconductor laser unit 50 has the semiconductor laser element 100 and the heater 109 integrated in a single housing. It is to be noted that the thermistor 110 will be described later.

Driven based on a drive current (forward current) supplied from a laser drive circuit 122, the semiconductor laser element 100 oscillates and outputs a laser beam of a given oscillation wavelength. The semiconductor laser element 100 is, for example, a red laser diode (CD standard: 780 nm in wavelength, DVD standard: 660 nm in wavelength) as used in the CD and DVD standards or a blue-purple laser diode (HDDVD standard: 405 nm in wavelength) as used in the HDDVD and other standards. It is to be noted that the semiconductor laser element 100 has the property that the oscillation wavelength is approximately proportional to the temperature (e.g., about 0.1 nm/° C.).

The heater 109 is an embodiment of the “heat generator” according to the present invention. The heater 109 generates heat to regulate the temperature of the semiconductor laser element 100. It is to be noted that a Peltier element, for example, may also be used other than the heater 109.

The peripheral circuitry of the semiconductor laser unit 50 will be described next.

A power monitor circuit 120 is used to monitor the light emission power of the semiconductor laser element 100. More specifically, the power monitor circuit 120 receives part of the laser beam, oscillated and output from the semiconductor laser element 100, with light receiving elements such as photodiodes. Therefore, the power monitor circuit 120 monitors the power of the laser beam, oscillated and output from the semiconductor laser element 100, based on the light reception level (amount of current) in the light receiving elements.

An APC (Automatic Power Control) circuit 121 exercises control so as to bring the light emission power of the semiconductor laser element 100, monitored by the power monitor circuit 120, into agreement with a preset reference power. More specifically, the APC circuit 121 supplies a control amount to the laser drive circuit 122 such that the laser drive circuit 122 generates a drive current corresponding to the difference between the monitored light emission power and the reference power.

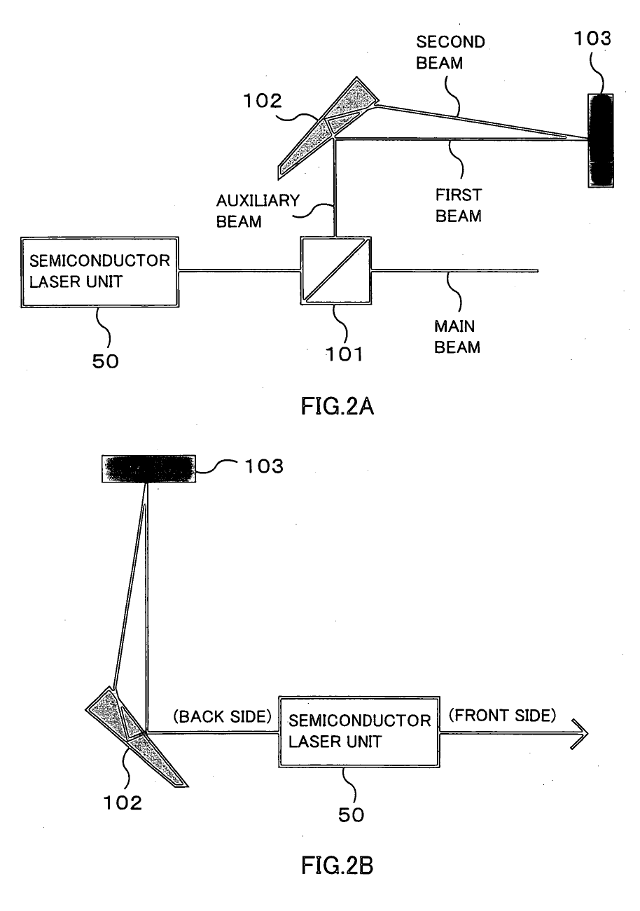

A PBS (Polarization Beam Splitter) 101 and a shear plate 102 are an embodiment of the “laser beam splitter” according to the present invention. FIG. 2A illustrates a part extracted from the optical system using the PBS 101, the shear plate 102 and the like. It is to be noted that FIG. 2A illustrates the splitting of the laser beam on the front side (side of the direction of the laser beam emission).

The PBS 101 is disposed on the front side of the semiconductor laser element 100. The PBS 101 receives the laser beam, emitted from the semiconductor laser element 100 toward the laser beam emission direction and splits the beam into main and auxiliary beams. It is to be noted that the main beam is employed for the optical and control systems provided at the later stage of PBS 101 in the system incorporating the semiconductor laser device 300. On the other hand, the auxiliary beam is used for the oscillation wavelength stabilization control according to the present invention. This enables the oscillation wavelength stabilization control according to the present invention to be exercised without affecting the optical and control systems at the later stage using the main beam.

Although the shear plate 102 has an approximate parallel-plate configuration, one surface and the other opposite thereto are each provided with a slope. Then, the shear plate 102 outputs, as the first beam, a reflected beam from the one surface obtained as a result of the striking of the laser beam on the one surface. On the other hand, the shear plate 102 outputs, as the second beam, a reflected beam from the other surface obtained as a result of the applying of the laser beam to the other surface after the transmission through the one surface. These first and second beams are overlapped with each other by a line CCD 103 that will be described later to form interference fringes. Thus, providing the shear plate 102 allows the ready splitting of the auxiliary beam into the first and second beams. It is to be noted that an optical system such as a PBS or half-mirror may be used other than the shear plate 102 to split the laser beam into the first and second beams to form two optical paths that will eventually overlap with each other.

On the other hand, while the laser beam, oscillated and output from the semiconductor laser element 100 on the front side of the semiconductor laser element 100, is split into the first and second beams to form the optical paths that will be eventually different from each other in the embodiment illustrated in FIG. 1, the laser beam may be split on the back side (side of the direction opposite to that of the laser beam emission) of the semiconductor laser element 100 as illustrated in FIG. 2B. In this case, the PBS 101 used for the beam splitting on the front side will become unnecessary. That is, the laser beam, emitted toward the back side of the semiconductor laser element 100, is split into the first and second beams as described above using, for example, the shear plate 102.

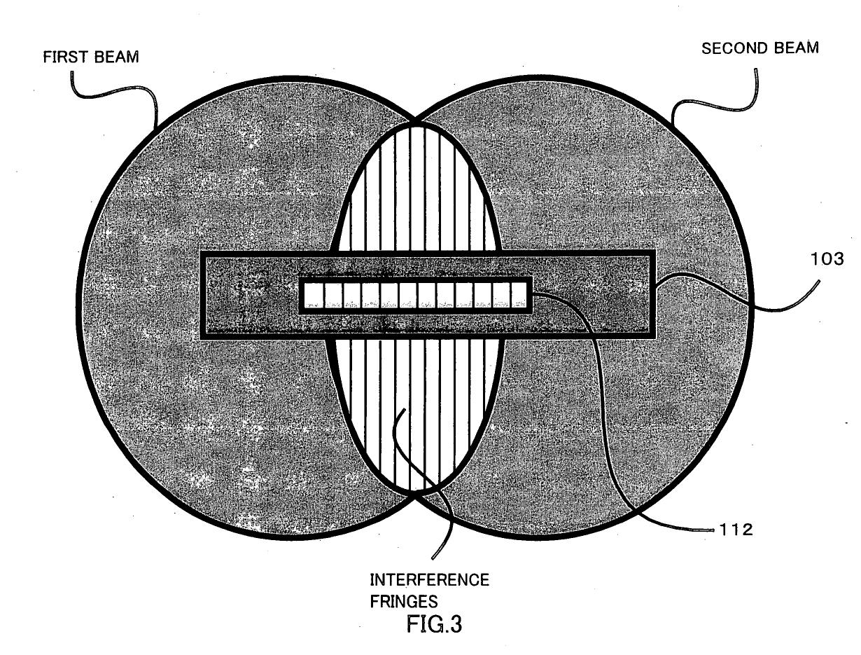

The line CCD (Charge Coupled Device) 103 is an embodiment of the “fringe spacing detector” according to the present invention. The line CCD 103 is configured by a plurality of light receiving elements 112 (e.g., photodiodes) disposed vertically to the formation direction of the linear interference fringes by the first and second beams and in a line as illustrated in FIG. 3. That is, the line CCD 103 receives the interference fringes, formed by the first and second beams, with the light receiving elements 112. Then, the line CCD 103 generates a detection signal CCDOUT, a signal having a period corresponding to the spacing between the disposed light receiving elements 112 and combining the light reception levels of the light receiving elements 112, based on a clock signal supplied from a clock generation circuit 104.

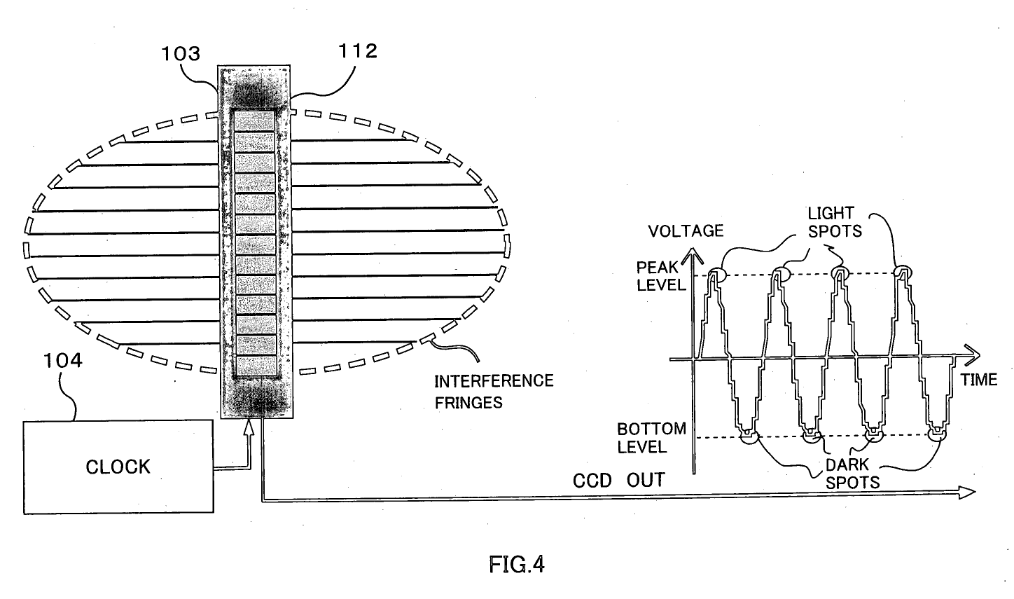

It is to be noted that the detection signal CCDOUT has one level (e.g., peak level) when the disposed positions of the light receiving elements 112 are aligned with the fringe positions as illustrated in FIG. 4, that is, when the light reception levels of the light receiving elements 112 are equal to the light intensity representing a light spot. On the other hand, the detection signal CCDOUT has another level (e.g., bottom level) when the disposed positions of the light receiving elements 112 are aligned with the positions between two fringes, that is, when the light reception levels of the light receiving elements 112 are equal to the light intensity representing a dark spot. Therefore, the spacing between adjacent levels of the detection signal CCDOUT, namely, the constant period of the detection signal CCDOUT, is an interference fringe spacing A.

Using the line CCD 103, a one-dimensional sensor, provides a high likelihood for the light receiving elements 112 to be opposed to the fringe positions, thus ensuring reduced missing detections. Besides, the necessary number of the light receiving elements 112 can be reduced to a required minimum level because of the line CCD 103. It is to be noted that an image sensor such as CMOS sensor may be used other than the line CCD 103. To hold down the number of the light receiving elements 112, however, it is preferred to use a one-dimensional sensor such as the line CCD 103 rather than a two-dimensional sensor.

Detailed description will be given here of the pixel count of the line CCD 103, namely, the number of the light receiving elements 112 in the line CCD 103. To satisfy the Nyquist condition, there must be at least as many of the light receiving elements 112 in the line CCD 103 as the number required to detect the interference fringes equivalent to 1A. It is to be noted that the Nyquist condition refers to the condition that a sampling frequency fs must be generally twice a maximum frequency fm or more of the sampling waveform. To detect the interference fringes equivalent to 1A, therefore, the minimum number of the light receiving elements 112 in the line CCD 103 is two. It is to be noted that, in reality, the number of the light receiving elements 112 is determined by “1A÷resolution ΔA” in a tradeoff with an appropriate resolution ΔA of the line CCD 103 for the detection of the interference fringes equivalent to 1A. For example, if the resolution ΔA of the line CCD 103 is “1A/1024”, then the 1024 (=1A÷(1A/1024)) light receiving elements 112 are required for the detection of the interference fringes equivalent to 1A.

Incidentally, the incidence angle of the first beam is expressed as θr and that of the second beam as θs, relative to the normal direction of the surface of the line CCD 103. In this case, the first beam is expressed as a wave function R in formula (1), and the second beam as a wave function S in formula (2).
R=exp^{-i(x sin θr+s cos θr)} Formula (1)
S=exp^{-i(x sin θs+s cos θs)} Formula (2)

As a result, the interference fringe spacing A is expressed by formula (3). It is to be noted that λ in formula (3) represents the wavelength of the first and second beams, namely, the wavelength of the laser beam oscillated and emitted from the semiconductor laser element 100.

$$A = \frac{λ}{\vert 2 sin ( \frac{θ r - θ s}{2} ) \vert} \qquad Formula ( 3 )$$

It is apparent from formula (3) that the interference fringe spacing A changes linearly with change in the wavelength λ. This makes it evident that if the interference fringe spacing A is kept constant, the wavelength of the laser beam, oscillated and emitted from the semiconductor laser element 100, can be stabilized.

A frequency-voltage converter 105, a differential amplifier 106, a reference voltage source 107 and a heater drive circuit 108 are an embodiment of the “heat generator” according to the present invention. That is, the analog circuits (105, 106, 107, 108) control the amount of heat generated by the heater 109 to keep the interference fringe spacing A. Even more specifically, the analog circuits (105, 106, 107, 108) control the amount of heat generated by the heater 109 correspondingly with the difference between a detection wavelength λd of the laser beam, determined by the interference fringe spacing A, and a preset reference wavelength λr of the laser beam that is the target wavelength.

Detailed description will be given below of the components of the analog circuits (105, 106, 107 and 108).

The frequency-voltage converter 105 converts a frequency fd of the detection signal CCDOUT, supplied from the line CCD 103, to a voltage vd.

The voltage Vd, converted by the frequency-voltage converter 105, is applied to the non-inverting input terminal of the differential amplifier 106, whereas the reference voltage Vr of the reference voltage source 107 is applied to the inverting input terminal thereof. It is to be noted that, in this case, the reference voltage Vr is a voltage determined by the reference frequency fr corresponding to the target laser beam reference wavelength λr. The differential amplifier 106 amplifies the difference (Vd−Vr) between the voltage Vd and the reference voltage Vr with a given amplification factor.

Applied with an output voltage VCTL of the differential amplifier 106, the heater drive circuit 108 drives the heater 109.

More specifically, if the voltage Vd is higher than the reference voltage Vr, then the detection frequency fd of the laser beam is higher than the reference frequency fr, and the detection wavelength λd of the laser beam is shorter than the reference wavelength λr. In this case, therefore, the output voltage VCTL is positive. As a result, the heater 109 is heated so as to lengthen the wavelength of the laser beam.

On the other hand, if the voltage Vd is lower than the reference voltage Vr, then the detection frequency fd of the laser beam is lower than the reference frequency fr, and the detection wavelength λd of the laser beam is longer than the reference wavelength λr. In this case, therefore, the output voltage VCTL is negative. As a result, the heater 109 is cooled so as to shorten the wavelength of the laser beam.

The above is the major configuration of the semiconductor laser device 300.

Incidentally, in the conventional method, the temperature of the semiconductor laser element 100 is kept constant while at the same time heating or cooling this element so as to indirectly stabilize the laser beam wavelength as illustrated in FIG. 12. In the present invention, on the other hand, the laser beam oscillated and output from the semiconductor laser element 100 is split into two beams or the first and second beams. Then, the amount of heat generated by the heat generator is controlled so as to keep constant the fringe spacing A between the interference fringes obtained as a result of the interference between the first and second beams. Here, the interference fringe spacing A is correlated with the laser beam wavelength. Therefore, keeping the interference fringe spacing A constant leads to the stabilization of the laser beam wavelength. The present invention takes advantage of this property to determine, with amore direct and easier arrangement as compared to the conventional method, whether the laser beam wavelength is stable.

It is to be noted that finding the laser beam wavelength, generally short, with the aforementioned embodiment, is in reality not easy. Therefore, the frequency-voltage converter 105 was used to find, at first, the voltage vd corresponding to the frequency fd of the detection signal CCDOUT reflecting the current interference fringe spacing A that was correlated with the current laser beam wavelength. Then, the amount of heat generated by the heater 109 is controlled based on the output voltage VCTL resulting from the amplification of the difference between the voltage Vd and the reference voltage Vr by the differential amplifier 106. That is, this means that the laser beam wavelength has been stabilized with a simple arrangement.

In the aforementioned embodiment, on the other hand, while the semiconductor laser element 100 should ideally oscillate in single mode, the element may oscillate in multimode as a result of changes in the environmental conditions and its characteristics. If the semiconductor laser element 100 oscillates in multimode, the frequency fd of the detection signal CCDOUT in the line CCD 103 is inappropriate. For this reason, the thermistor 110 and a temperature-voltage converter 111 are further provided as a countermeasure against multimode as illustrated in FIG. 1.

The thermistor 110 is an embodiment of the “temperature detector” according to the present invention. The thermistor 110 detects the temperature of the semiconductor laser element 100. It is to be noted that a device such as a thermocouple or resistance temperature sensor may be used, for example, other than the thermistor 110.

The temperature-voltage converter 111 converts a detection temperature Td, detected by the thermistor 110, to a corresponding voltage VT. It is to be noted that the voltage VT and the output voltage Vd of the differential amplifier 106 are added and applied to the heater drive circuit 108.

It is to be noted that, in this case, the reference voltage Vr, applied to the inverting input terminal of the differential amplifier 106, is the sum of the reference voltage Vr corresponding to the target reference wavelength λr of the laser beam and the voltage corresponding to the given reference voltage in the thermistor 110.

Thus, even in multimode, the temperature control adapted to achieve the wavelength stabilization according to the present invention is carried out while at the same time leaving the control, exercised by the frequency-voltage converter 105 and the differential amplifier 106, active. The reason for this is that it involves, in reality, extreme difficulties in the realization of an arrangement operable to detect whether the semiconductor laser element 100 oscillates in multimode and to stop the operation of the frequency-voltage converter 105 and others in the case of an analog circuit configuration with the frequency-voltage converter 105 and other analog circuitry.

### Second Embodiment

### Heat Generation Controller Configured with Digital Circuitry

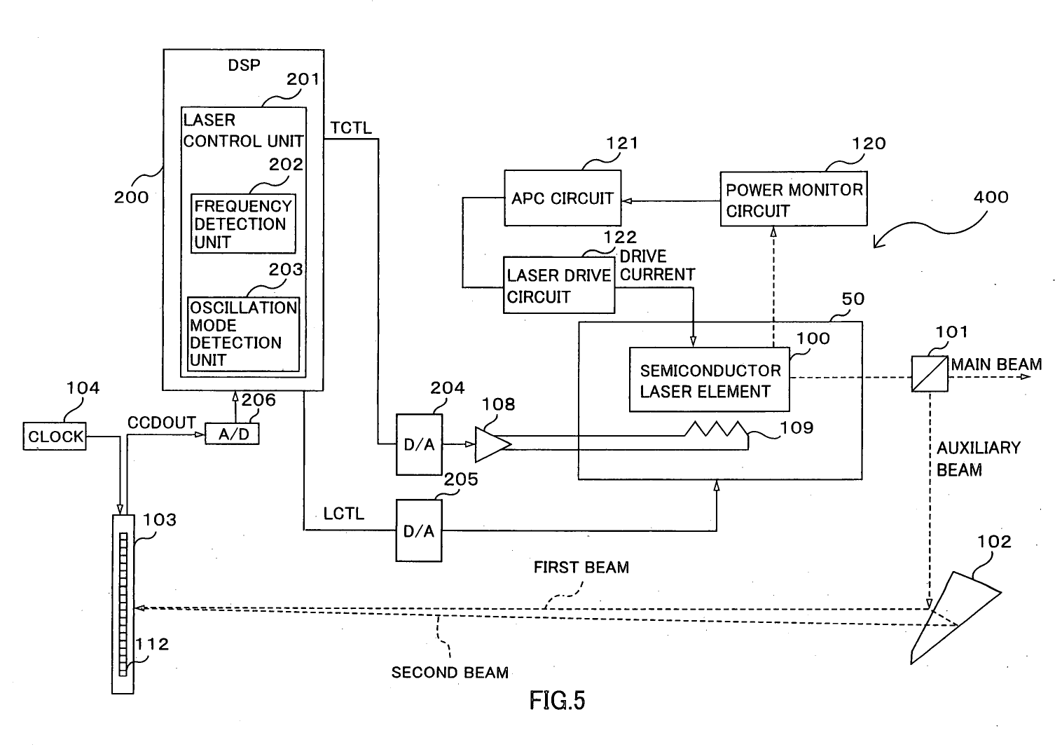

FIG. 5 illustrates the overall configuration of a semiconductor laser device 400 according to a second embodiment of the present invention. It is to be noted that the same reference numerals are used to designate like components as those in the semiconductor laser device 300 according to the first embodiment of the present invention illustrated in FIG. 1.

The semiconductor laser device 400 illustrated in FIG. 5 differs considerably in that the heat generation controller, configured with analog circuitry in the semiconductor laser device 300 illustrated in FIG. 1, has been replaced with a digital circuit configuration using a DSP (Digital Signal Processor) 200. Description will be given below of the DSP 200 and the peripheral circuitry thereof.

The minimum number of the light receiving elements 112 required in the line CCD 103 is two as in the first embodiment in order to detect at least the interference fringes equivalent to 1A. It is to be noted that the detection of the interference fringes equivalent to 2A is actually most effective to accommodate the variation in laser wavelength. It is also to be noted that, in a tradeoff with a resolution Δ2A of the line CCD 103 to detect the interference fringes equivalent to 2A, the number of the light receiving elements 112 is determined by “2A÷resolution Δ2A÷2” in the case of fast Fourier transform because of the fact that the general sampling count for discrete Fourier transform is only ½. For example, if the resolution Δ2A of the line CCD 103 is “2A/1024”, at least the 512 (=2A÷(2A/1024)) light receiving elements 112 are required to detect the interference fringes equivalent to 2A.

Detailed description will be given below of the reason why the detection of the interference fringes equivalent to 2A is most effective. That is, the variation in laser wavelength is actually marginal. This eliminates the need to detect a number of interference fringes in order to accommodate such a variation. Moreover, in the fast Fourier transform process of the DSP 200 described later, a time window (sampling data acquisition interval) function in the form of a rectangular wave is employed. In this case, the resolution of the line CCD 103 improves as compared to other time window functions such as that in the form of a triangular wave. On the other hand, however, a Fourier spectrum error (waveform discontinuity) occurs as a result of the asynchronization in one period between the time window and the sampling waveform. Here, the time window function in the form of a rectangular wave can avoid the Fourier spectrum error if the time window is multiplied by an integer. Therefore, the minimum time window needs only be doubled in time. As a consequence, it is most effective to detect the interference fringes equivalent to 2A.

An A/D converter 206 converts the detection signal CCDOUT of an analog quantity generated by the line CCD 103 to a digital quantity. It is to be noted that the detection signal CCDOUT is supplied to the DSP 200 after the A/D conversion.

The DSP 200 is an embodiment of the “digital signal processor” according to the present invention.

The DSP 200 has a laser control unit 201 operable to regulate the temperature for the wavelength stabilization according to the present invention. On the other hand, the laser control unit 201 has a frequency detection unit 202 and an oscillation mode detection unit 203. It is to be noted that the individual processes conducted in the laser control unit 201, the frequency detection unit 202 and the oscillation mode detection unit 203 are handled by software using the multiply-add calculator of the DSP 200.

The frequency detection unit 202 subjects the detection signal CCDOUT after the A/D conversion to the discrete Fourier transform process (preferably the fast Fourier transform process) to obtain Fourier spectra. Further, the frequency detection unit 202 detects a frequency F0 of the main spectrum with the maximum power among the Fourier spectra.

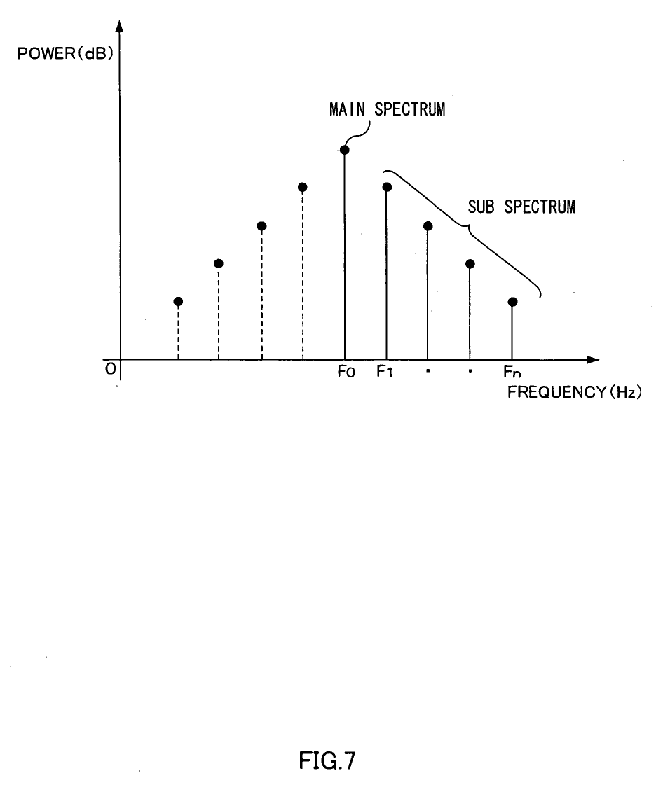

It is to be noted that FIG. 7 illustrates an example of the Fourier spectra obtained from the fast Fourier transform process. As illustrated in FIG. 7, the Fourier spectra are a distribution of frequency (Hz) vs power or spectrum density (db). It is also to be noted that subspectra with a frequency Fk (k=0 to n) appear in a bilaterally symmetrical manner with respect to the main spectrum with the maximum power and at the frequency F0 in the Fourier spectra. It is to be noted that, in the case of fast Fourier transform, the subspectra on either the left or right side are obtained. Thus, the frequency detection unit 202 obtains, in a simplified manner, the frequency fd of the detection signal CCDOUT as the frequency F0 of the main spectrum obtained from the general fast Fourier transform process.

The oscillation mode detection unit 203 determines whether the semiconductor laser element 100 oscillates in single mode or multimode in response to the statuses of the individual frequency components of the Fourier spectra obtained by the frequency detection unit 202. Thus, the determination of whether the oscillation occurs in single mode or multimode can also be realized in a simplified manner based on the Fourier spectra obtained from the general fast Fourier transform process.

The laser control unit 201 generates a control signal TCTL adapted to control the amount of heat generated by the heater 109, based on the result of comparison between a fundamental frequency f0 of the Fourier spectra obtained by the frequency detection unit 202 and the reference frequency fr corresponding to the target reference wavelength λr of the laser beam. It is to be noted that the control signal TCTL is supplied to the heater drive circuit 108 after the D/A conversion by a D/A converter 204. As a result, the fundamental frequency f0 of the Fourier spectra matches the reference frequency fr of the laser beam. That is, the temperature of the semiconductor laser element 100 stabilizes so as to stabilize the laser beam wavelength.

The laser control unit 201 generates a control signal LCTL to exercise control so as to disable the laser beam if the oscillation mode detection unit 203 determines that the semiconductor laser element 100 oscillates in multimode. It is to be noted that the control to disable the laser beam consists, for example, of defocusing the laser beam emitted from the semiconductor laser element 100. The control signal LCTL is supplied to the servo mechanism (not shown) around the semiconductor laser unit 50 after the D/A conversion by a D/A converter 205. This prevents the temperature of the semiconductor laser element 100 from being improperly regulated if the semiconductor laser element 100 oscillates in multimode.

Incidentally, if the semiconductor laser element 100 is temporarily stopped from being driven, a large amount of time is required to stabilize its oscillation output after the semiconductor laser element 100 is driven again. For this reason, it is more preferred to continuously drive the semiconductor laser element 100. Therefore, if the oscillation mode detection unit 203 determines that the semiconductor laser element 100 oscillates in multimode, the laser control unit 201 exercises control so as to disable the laser beam rather than stop driving the semiconductor laser element 100.

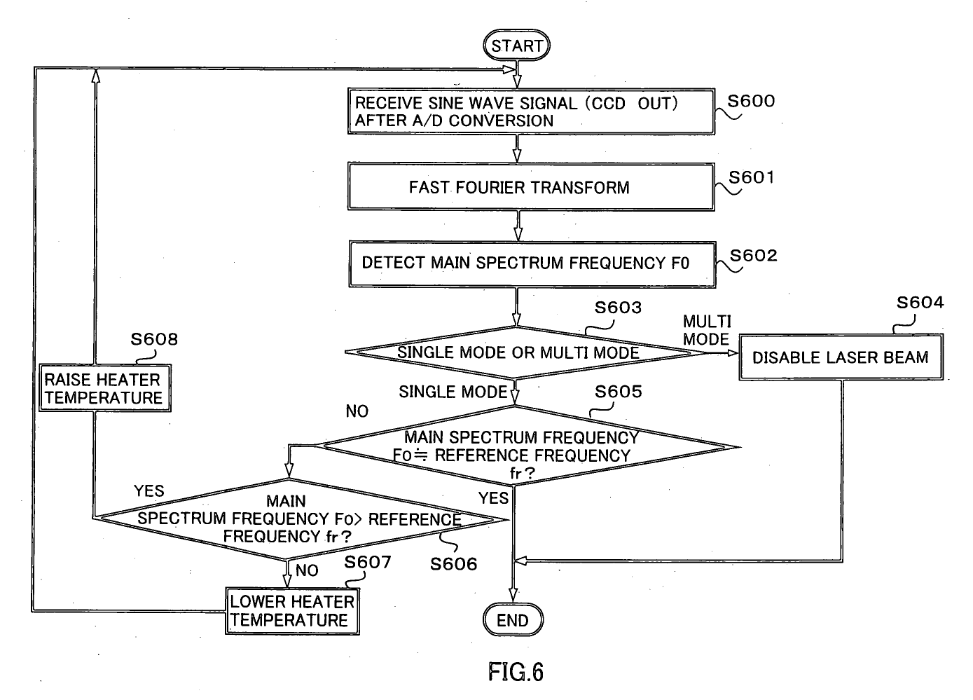

FIG. 6 is a flowchart illustrating the detailed process flow of the DSP 200.

First, upon receiving the detection signal CCDOUT in sine wave form after the A/D conversion from the A/D converter 206 (S600), the DSP 200 subjects the detection signal CCDOUT to the fast Fourier transform process (S601). This allows the DSP 200 to obtain Fourier spectra related to the detection signal CCDOUT. Further, the DSP 200 identifies the frequency F0 of the main spectrum with the maximum power among the Fourier spectra (S602).

Next, the DSP 200 determines whether the Fourier spectra stabilize at regular frequencies (single mode) or emerge at various irregular frequencies (multimode) (S603). For example, when the frequencies of the Fourier spectra appear in a bilaterally symmetrical manner with respect to the main spectrum at the frequency F0 and periodically as illustrated in FIG. 7, the DSP 200 determines that the semiconductor laser element 100 oscillates in single mode. On the other hand, if the frequencies of the Fourier spectra do not appear in a bilaterally symmetrical manner with respect to the main spectrum at the frequency F0 and periodically, the DSP 200 determines that the semiconductor laser element 100 oscillates in multimode.

If it is determined that the semiconductor laser element 100 oscillates in multimode rather than in single mode (S603: multimode), the DSP 200 generates the control signal LCTL to disable the laser beam (S604). As a result, the laser beam is disabled if the semiconductor laser element 100 oscillates in multimode. On the other hand, when it is determined that the semiconductor laser element 100 oscillates in single mode (S603: single mode), the DSP 200 determines whether the obtained main spectrum frequency F0 approximately matches the target laser beam reference frequency fr (S605).

When the main spectrum frequency F0 is determined to approximately match the reference frequency fr (S605: YES), the DSP 200 considers that the wavelength of the semiconductor laser element 100 has stabilized. On the other hand, if it is determined that the main spectrum frequency F0 is determined not to approximately match the reference frequency fr (S605: NO), the DSP 200 determines whether the main spectrum frequency F0 is higher than the reference frequency fr (S606).

If the DSP 200 determines that the main spectrum frequency F0 is lower than the reference frequency fr (S606: NO), the laser beam detection wavelength λd is longer than the target reference wavelength λr. Therefore, the DSP 200 generates the control signal TCTL to cool the heater 109 and lower its temperature (S607). This causes the laser beam detection wavelength λd to become shorter and, in turn, the main spectrum frequency F0 to rise as a result of the cooling of the heater 109.

On the other hand, when the DSP 200 determines that the main spectrum frequency F0 is higher than the reference frequency fr (S606: YES), the laser beam detection wavelength λd is shorter than the target reference wavelength % r. Therefore, the DSP 200 generates the control signal TCTL to heat the heater 109 and raise its temperature (S607). This causes the laser beam detection wavelength λd to become longer and, in turn, the main spectrum frequency F0 to lower as a result of the heating of the heater 109.

Then, the DSP 200 repeats the processes from S600 to S608 until the main spectrum frequency F0 approximately matches the reference frequency fr.

### Other Embodiment

It is to be noted that at least the two light receiving elements 112 are disposed so as to be opposed to the interference fringes generated by the first and second beams instead of employing the line CCD 103 in the aforementioned first and second embodiments. Moreover, the spacing between the disposed light receiving elements 112 is caused to match the spacing that is an integral multiple of the interference fringe spacing A. Here, when at least each of the two light receiving elements 112 is opposed to the interference fringe position, at least the light reception levels of these elements roughly match each other. On the other hand, if the interference fringe opposed to at least one of the light receiving elements 112 is displaced, at least the light reception levels of these elements do not match each other. Therefore, when at least the light reception levels (e.g., peak levels) of the light receiving elements 112 are caused to match each other, the interference fringe spacing can be kept constant in a simplified manner.

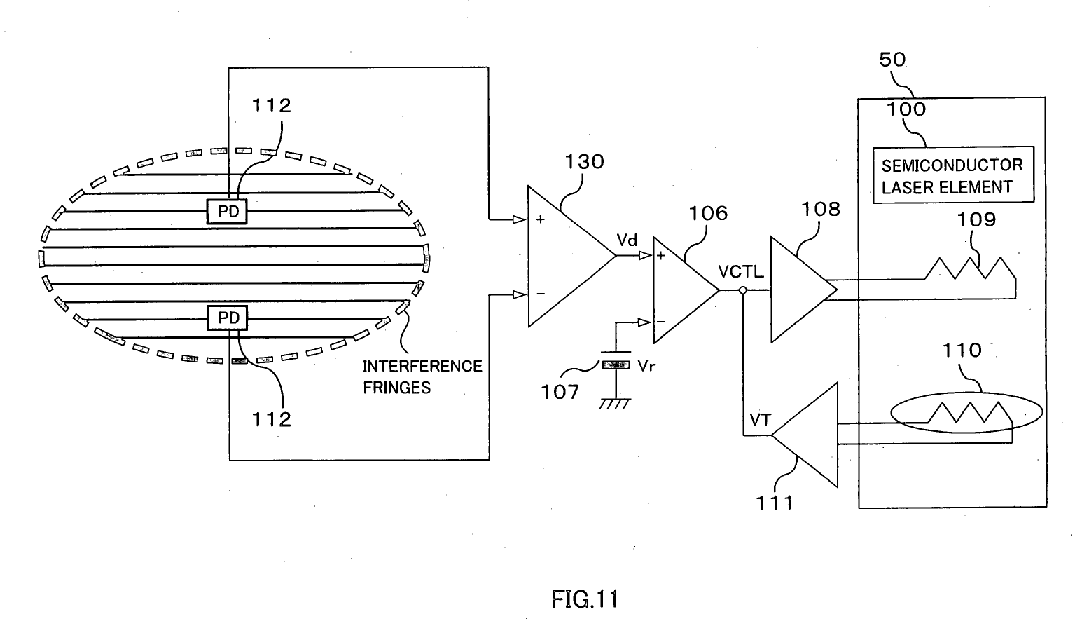

FIG. 11 illustrates the configuration of a semiconductor laser device in this case. It is to be noted that the line CCD 103 and the frequency-voltage converter 105 illustrated in FIG. 1 have been replaced respectively with the two light receiving elements 112 and a differential amplifier 130 in the configuration illustrated in FIG. 11.

As illustrated in FIG. 11, the spacing between the disposed light receiving elements 112 was, for example, set equal to an interference fringe spacing 6A. Therefore, if each of the light receiving elements 112 is opposed to the interference fringe position, the light reception levels of the elements roughly match each other. For this reason, the reference voltage Vr of the reference voltage source 107 is set equal to the output voltage Vd of the differential amplifier 130 when the light reception levels of the light receiving elements 112 roughly match each other.

Then, the differential amplifier 106 generates the output voltage VCTL through the differential amplification of the output voltage Vd of the differential amplifier 130 applied to the non-inverting input terminal and the reference voltage Vr of the reference voltage source 107 applied to the inverting input terminal. Based on the output voltage VCTL, the heater 109 is driven via the heater drive circuit 108. This causes the temperature of the semiconductor laser element 100 to be regulated, and in turn, the laser beam oscillation wavelength to be regulated, thus changing the interference fringe spacing.

As a consequence, the output voltage VCTL of the differential amplifier 106 declines in level. That is, when the light reception levels of the light receiving elements 112 roughly match each other, the laser beam oscillation wavelength λ stabilizes.

<Application to the Hologram Apparatus>

The semiconductor laser device according to the present invention such as the semiconductor laser device 300 or 400 may be incorporated, for example, into an existing optical disk apparatus operable to irradiate a red laser beam onto an existing optical disk compliant with the CD, DVD or other standard and record and play back information, or a next-generation optical disk apparatus operable to irradiate a blue laser beam onto a next-generation optical disk such as BlueRay or HDDVD and record and play back information.

Further, the semiconductor laser device according to the present invention may be incorporated into a hologram apparatus operable to record information to and play back information from a medium such as photosensitive resin as interference fringes. It is to be noted that the stabilization of the laser beam wavelength is extremely important in a hologram apparatus that is required to ensure equal or higher accuracy in control than optical disk apparatuses. Therefore, description will be given below of a hologram apparatus incorporating the semiconductor laser device according to the present invention.

===Outline of the Hologram Apparatus===

Among hologram recording media adapted to record digital data as a hologram is a medium that has a photosensitive resin (e.g., photopolymer) sealed between glass substrates. To record digital data on a hologram recording medium as a hologram, a coherent laser beam from the semiconductor laser device is first split into two laser beams with a PBS (Polarization Beam Splitter). Then, two laser beams, one (hereinafter referred to as “reference beam”) and the other (hereinafter referred to as “data beam”) reflecting the information of two-dimensional gray image pattern formed in an SLM (Spatial Light Modulator) obtained as a result of the irradiation of the other beam into the SLM having digital data formed as the two-dimensional gray image pattern, are applied to the hologram recording medium at a given angle. This causes the target digital data to be recorded in the hologram recording medium.

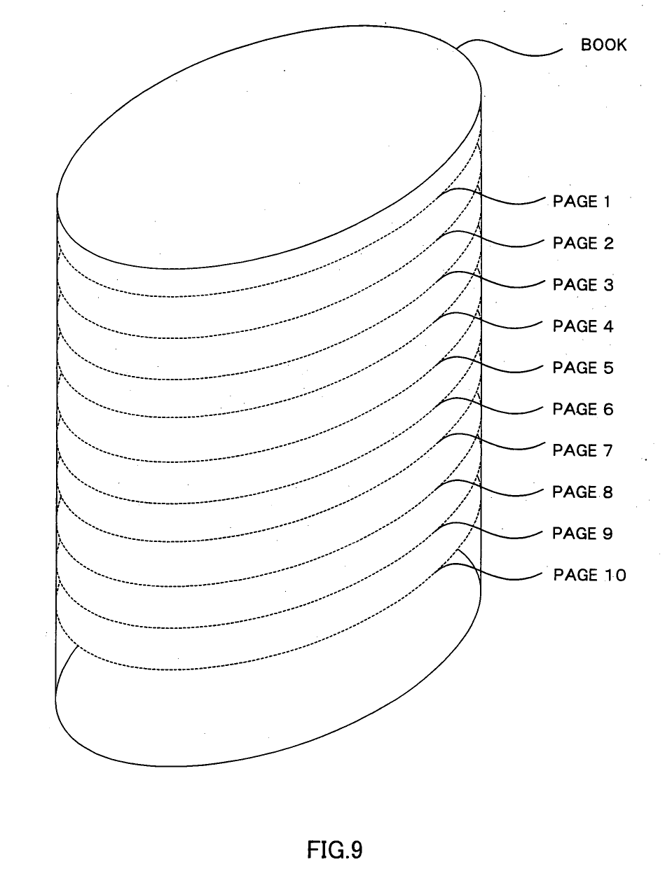

More specifically, the photosensitive resin making up the hologram recording medium has a finite number of monomers. When the laser beam (hereinafter referred to as “laser beam”) made up of the reference and data beams is irradiated thereinto, the monomers change into polymers correspondingly with the energy determined by the light intensity of the laser beam and the irradiation time. As a result of the transformation of the monomers into polymers, an interference fringe, made up of polymers, is formed correspondingly with the laser beam energy. Moreover, as a result of the formation of such an interference fringe in the hologram recording medium, digital data is recorded as a hologram. Later, remaining monomers migrate (spread) to those locations that have consumed monomers. Further, as a result of the irradiation of the laser beam, such monomers change into polymers. It is to be noted that FIG. 9 schematically illustrates how monomers transform into polymers correspondingly with the laser beam energy in the hologram recording medium.

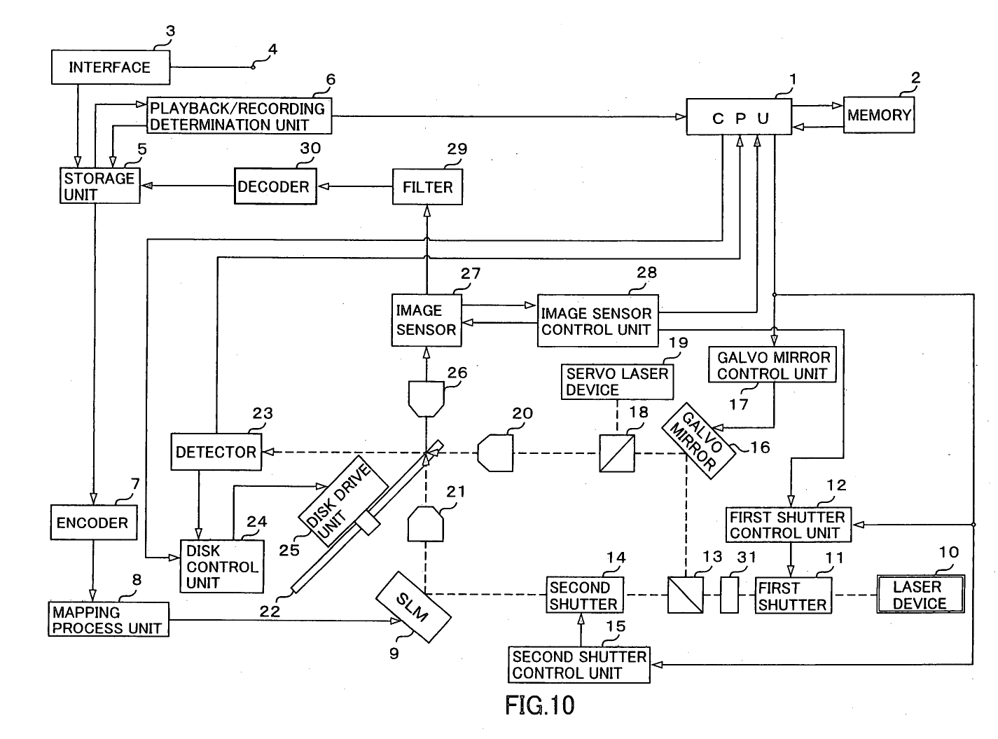

It is also to be noted that if a large amount of digital data must be recorded in the hologram recording medium, the incidence angle of the reference beam into the hologram recording medium is changed to enable the so-called “angle-multiplexed recording” adapted to form a number of holograms. For example, a hologram formed in the hologram recording medium is called a page, whereas a multiplexed hologram made up of a number of pages is called a book. FIG. 10 schematically illustrates the book and the pages in the angle-multiplexed recording. As shown in FIG. 10, the incidence angle of the reference beam is varied to form, for example, ten pages of holograms for a single book in the angle-multiplexed recording. Thus, the angle-multiplexed recording allows for the recording of a large amount of digital data.

To play back digital data from the hologram recording medium, on the other hand, the reference beam is irradiated into the interference fringe representing the digital data at the same incidence angle as when the interference fringe was formed. The reference beam (hereinafter referred to as “playback beam”) diffracted by the interference fringe is received by an image sensor or other means. The playback beam received by the image sensor or other means constitutes a two-dimensional gray image pattern representing the above-described digital data. Then, the digital data can be demodulated from this two-dimensional gray image pattern with a decoder or other means to play back the digital data.

===Overall Configuration of the Hologram Apparatus===

Description will be given of the configuration of the hologram apparatus according to an embodiment of the present invention based on FIG. 10. It is to be noted that the hologram apparatus illustrated in FIG. 10 is a hologram recording/playback apparatus capable of recording a hologram to and playing back a recorded hologram from a hologram recording medium 22. A hologram apparatus may naturally be used that can either record or play back a hologram.

An interface 3 handles data exchange between host equipment (e.g., PC, workstation) connected via a connection terminal 4 and the hologram apparatus.

A buffer 5 stores playback instruction data from the host equipment adapted to play back the data stored in the hologram recording medium 22. The buffer 5 also stores recording instruction data adapted to store the bit string data from the host equipment in the hologram recording medium 22. The buffer 5 further stores the bit string data to be recorded in the hologram recording medium 22.

A playback/recording determination unit 6 determines at a specified timing whether a playback or recording instruction signal is recorded in the buffer 5. When determining that a playback instruction signal is recorded in the buffer 5, the playback/recording determination unit 6 sends an instruction signal to carry out the playback process in the hologram recording/playback apparatus to a CPU 1. When determining that a recording instruction signal is recorded in the buffer 5, on the other hand, the playback/recording determination unit 6 sends an instruction signal to carry out the recording process in the hologram recording/playback apparatus to the CPU 1 to cause the buffer 5 to send to an encoder 7 the data from the host equipment to be recorded in the hologram recording medium 22. Further, the playback/recording determination unit 6 sends data volume information on the volume of data to be recorded in the hologram recording medium 22 to the CPU 1.

The encoder 7 first stores the bit string data transferred from the buffer 5 in a memory (not shown) such as SRAM or DRAM that is accessible by the encoder 7. Then, the encoder 7 carries out the encoding process on the bit string data stored in the memory such as adding error correction code to the data and then supplies the data to a mapping process unit 8. Here, the unit bit string data subjected to the encoding process is called modulated code.

The mapping process unit 8 converts the modulated code supplied from the encoder 7 to modulated image data constituting the layout pattern of the code (e.g., 1280 bits down×1280 bits across˜1.6 Mbits). Then, the mapping process unit 8 supplies the modulated image data to an SLM 9.

The SLM 9 forms a two-dimensional gray image pattern based on the modulated image data supplied from the encoder 7. Here, the two-dimensional gray image pattern refers to a pattern formed by taking one of the values (e.g., 1) of each of the bits making up the modulated image data as a light spot (light) and the other (e.g., 0) as a dark spot (shade). It is to be noted that the data beam reflecting the light spot has a light intensity that consumes monomers, whereas the data beam reflecting the dark spot has a light intensity that does not lead to the consumption of monomers.

Here, the SLM 9 expresses approximately 1.6-Mbit modulated image data as a dot pattern with 1280 pixels down by 1280 pixels across. On the other hand, when the laser beam from a laser device 10 is applied to the SLM 9, the SLM 9 reflects the beam toward a Fourier transform lens 21. This reflected beam turns into a laser beam (hereinafter referred to as “data beam”) reflecting the two-dimensional gray image pattern formed by the SLM 9. It is to be noted that the present invention is not limited to when the other laser beam from a PBS 13 is directly applied to the SLM 9 as shown in FIG. 1. For example, a PBS (not shown) may be provided in the optical path between a second shutter 14 and the SLM 9 such that the laser beam split by the PBS is applied to the SLM 9.

The laser device 10 emits a coherent laser beam, excellent in time and space coherence, to a first shutter 11. Among the lasers used for the laser device 10 to form a hologram on the hologram recording medium 22 are helium-neon, argon-neon, helium-cadmium, semiconductor, dye and ruby lasers.

The CPU 1 exercises centralized control over the entire hologram apparatus (system). Upon receiving an instruction signal based on the recording instruction data from the playback/recording determination unit 6, the CPU 1 reads the address information from the pit formed on the hologram recording medium 22. Then, the CPU 1 sends an instruction signal to a disk control unit 24 to rotate the hologram recording medium 22 so as to irradiate the laser beam from a servo laser device 19 (hereinafter referred to as “servo laser beam”) onto the pit on the hologram recording medium 22 representing the next address information.

On the other hand, the CPU 1 sends an instruction signal to a galvo mirror control unit 17 to cause this unit to adjust the inclination angle of a galvo mirror 16. The CPU 1 also calculates the number of holograms (i.e., number of pages) formed in the hologram recording medium 22 based on the data volume information from the playback/recording determination unit 6. On the other hand, the CPU 1 sends an instruction signal to each of the first and second shutter control units 12 and 15 so as to respectively open the first and second shutters 11 and 14. This initiates the hologram recording to the hologram recording medium 22. Then, at the end of the recording process based on the recording instruction data, the CPU 1 sends an instruction signal to each of the first and second shutter control unit 12 and 15 so as to respectively close the first and second shutters 11 and 14. This terminates the hologram recording to the hologram recording medium 22.

On the other hand, upon receiving an instruction signal based on the playback instruction data from the playback/recording determination unit 6, the CPU 1 sends an instruction signal to rotate the hologram recording medium 22 to the disk control unit 24 so as to irradiate the servo laser beam from the servo laser device 19 onto the pit in the hologram recording medium 22 representing the address information that corresponds to the playback instruction signal.

Further, upon receiving an instruction signal based on the playback instruction data, the CPU 1 sends an instruction signal to the first shutter control unit 12 to open the first shutter 11 and another signal to the second shutter control unit 15 to close the second shutter 14. The CPU 1 also sends an instruction signal to the galvo mirror control unit 17 to cause this unit to adjust the inclination angle of the galvo mirror 16. This initiates the hologram playback from the hologram recording medium 22. Then, when determining that the given period of time has elapsed in the playback process based on the playback instruction data, the CPU 1 sends an instruction signal to the first shutter control unit 12 to close the first shutter 11. This terminates the hologram playback from the hologram recording medium 22.

The first shutter control unit 12 exercises control so as to open or close the first shutter 11 based on the instruction signal from the CPU 1. The first shutter control unit 12 also exercises control so as to close the first shutter 11 based on the instruction signal from an image sensor control unit 28. When opening the first shutter 11, the first shutter control unit 12 sends an opening instruction signal to the first shutter 11. On the other hand, when closing the first shutter 11, the first shutter control unit 12 sends a closing instruction signal to the first shutter 11.

The first shutter 11 opens based on the opening instruction signal from the first shutter control unit 12. Alternatively, the first shutter 11 closes based on the closing instruction signal from the first shutter control unit 12. When the first shutter 11 closes, the laser beam from the laser device 10 is interrupted from striking a ½ wavelength plate 31.

The ½ wavelength plate 31 is provided at a given inclination so as to determine the angle for the laser beam from the laser device 10 to be applied to the PBS 13. It is to be noted that this given inclination is determined so as to achieve a desired split ratio of the two laser beams split by the PBS 13.

The PBS 13 splits the laser beam from the ½ wavelength plate 31 into two laser beams. One of the laser beams split by the PBS 13 strikes the second shutter 14. On the other hand, the other laser beam (hereinafter referred to as “reference beam”) is applied to the galvo mirror 16.

The galvo mirror 16 reflects the reference beam from the PBS 13 to a dichroic mirror 18.

The galvo mirror control unit 17 adjusts the inclination angle of the galvo mirror 16 so as to adjust the angle for the reference beam, reflected by the galvo mirror 16, to be applied to the hologram recording medium 22 via the dichroic mirror 18 and a scanner lens 20, based on the instruction signal from the CPU 1. This inclination angle adjustment of the galvo mirror 16 by the galvo mirror control unit 17 is carried out during the hologram recording to ensure that the two-dimensional gray image pattern information is recorded in the hologram recording medium 22 as a hologram.

More specifically, a three-dimensional interference fringe (hologram) is formed as a result of the interference between the data and reference beams within the hologram recording medium 22. That is, as a result of the formation of a hologram in the hologram recording medium 22, the two-dimensional gray image pattern information set in the SLM 9 is recorded. On the other hand, the galvo mirror control unit 17 adjusts the inclination angle of the galvo mirror 16, that is, adjusts the incidence angle of the reference beam into the hologram recording medium 22, to enable the angle-multiplexed recording. Here, a hologram formed on the hologram recording medium 22 is referred to as a page, and a multiplexed recorded hologram with a number of pages one above the other created by the angle-multiplexed recording as a book.

During the hologram playback, on the other hand, the galvo mirror control unit 17 adjusts the inclination angle of the galvo mirror 16 so as to apply the reference beam to the hologram formed in the hologram recording medium 22. It is to be noted that this inclination angle adjustment of the galvo mirror 16 is carried out during the hologram playback to ensure that the reference beam is applied to the hologram at the same incidence angle as the reference beam during the hologram recording.

The servo laser device 19 emits a servo laser beam to the dichroic mirror 18 so as to irradiate the beam onto a pit in the hologram recording medium 22 and detect the position of the hologram formed in the hologram recording medium 22 based on the address information represented by the pit. The servo laser beam emitted from the servo laser device 19 is a beam at a given wavelength that does not affect the hologram formed in the hologram recording medium 22. It is to be noted that a blue laser beam is used as the laser beam emitted from the laser device 10 and that a red laser beam, longer in wavelength than the blue laser beam, is used as the servo laser beam.

The emission of the servo laser beam from the servo laser device 19 begins, for example, when the hologram apparatus starts its operation, and the servo laser device 19 continues to emit the beam while the hologram apparatus remains in operation. Although the servo laser device 19 is assumed to continue its emission, the present invention is not limited thereto. During the data recording to the hologram recording medium 22 by the hologram apparatus, for example, the hologram recording medium 22 pauses. For this reason, the irradiation of the servo laser beam by the servo laser device 19 may be halted during the period of time when the irradiation of the beam onto the pit is not necessarily required. This can reduce the load derived from the emission of the servo laser beam from the servo laser device 19.

The dichroic mirror 18 transmits the reference beam reflected by the galvo mirror 16 to apply the reference beam to the scanner lens 20. On the other hand, the dichroic mirror 18 reflects the servo laser beam emitted from the servo laser device 19 to apply the laser beam to the scanner lens 20.

The scanner lens 20 refracts the reference beam, i.e., the beam incident via the dichroic mirror 18 from the galvo mirror 16 that has been adjusted in inclination angle by the galvo mirror control unit 17, so as to ensure the positive irradiation of the beam into the hologram recording medium 22. The scanner lens 20 also applies the servo laser beam from the servo laser device 19, reflected by the dichroic mirror 18, to the hologram recording medium 22.

The second shutter control unit 15 exercises control so as to open or close the second shutter 14 based on the instruction signal from the CPU 1. When opening the second shutter 14, the second shutter control unit 15 sends an opening instruction signal to the second shutter 14. When closing the second shutter 14, on the other hand, the second shutter control unit 15 sends a closing instruction signal to the second shutter 14.

The second shutter 14 opens based on the opening instruction signal from the second shutter control unit 15. Alternatively, the second shutter 14 closes based on the closing instruction signal from the second shutter control unit 15. When the second shutter 14 closes, one of the laser beams split by the PBS 13 is interrupted from being applied to the SLM 9. It is to be noted that the second shutter 14 may be provided in the optical path of the data beam from the SLM 9 incident upon the hologram recording medium 22 via the Fourier transform lens 21.

The Fourier transform lens 21 first subjects the data beam to the Fourier transform process and then applies the beam to the hologram recording medium 22 while collecting the data beam from the SLM 9.

A photosensitive resin (e.g., photopolymer, silver salt emulsion, gelatine bichromate, photoresist), capable of storing data as a hologram, is used for the hologram recording medium 22. This resin is sealed between glass substrates to configure the hologram recording medium 22. A hologram is formed in the hologram recording medium 22 as a result of the interference between the Fourier-transformed data beam from the Fourier transform lens 21 representing a two-dimensional gray image pattern and the reference beam from the scanner lens 20. Then, the inclination angle of the galvo mirror 16 is adjusted by the galvo mirror control unit 17 to record data again in the hologram recording medium 22. The angle-multiplexed recording is carried out as a result of the interference between the reference beam from the galvo mirror 16 that has been adjusted in inclination angle and the data beam. This allows a book to be formed.

On the other hand, wobbles are, for example, formed in advance on the glass substrates making up the hologram recording medium 22 so that address information is formed in advance in the wobbles as pits to determine the positions of the holograms formed in the hologram recording medium 22. Then, the servo laser beam, incident from the scanner lens 20 and emitted from the servo laser device 19, is irradiated onto the pit representing the address information. After the irradiation onto the pit representing the address information, the servo laser beam is applied to the detector 23.

A Fourier transform lens 26 receives the beam (hereinafter referred to as playback beam) diffracted by the hologram recorded in the hologram recording medium 22 when the reference beam is applied to the hologram recording medium 22 during the hologram playback. It is to be noted that the incidence angle of the reference beam during the hologram playback must be the same as that of the reference beam during the recording of the hologram to be played back. Then, the Fourier transform lens 26 emits the inverse-Fourier-transformed playback beam to an image sensor 27.

The image sensor 27 receives the inverse-Fourier-transformed playback beam from the Fourier transform lens 26. The image sensor 27 is configured, for example, with a CCD or CMOS sensor to reproduce, from the playback beam, the two-dimensional gray image pattern set in the SLM 9. Here, the reproduced two-dimensional gray image pattern is referred to as a captured image pattern. The image sensor 27 converts the lightness or darkness of the captured image pattern into the difference in electric signal intensity based on the instruction signal from the image sensor control unit 28. Then, the image sensor 27 supplies, to a filter 29, the modulated image data in analog quantity corresponding to the light intensity of the lightness or darkness of the captured image pattern. It is to be noted that if the image sensor control unit 28 determines that the image sensor 27 has been irradiated with the playback beam with the given light intensity or more in the present embodiment, the image sensor control unit 28 sends an instruction signal to the first shutter control unit 12 to close the first shutter 11.

On the other hand, we assume that the SLM 9 and the image sensor 27 can both create image patterns of the same size (e.g., 1280 pixels by 1280 pixels) in the present embodiment. It is to be noted that while we assume that the SLM 9 and the image sensor 27 can both create image patterns of the same size, the present invention is not limited thereto. For example, the image size of the image sensor 27 may be larger than that of the SLM 9. If the image size of the image sensor 27 is larger than that of the SLM 9, the playback beam from the Fourier transform lens 26 will be positively irradiated onto the image sensor 27. This allows the positive reproduction of the two-dimensional gray image pattern set in the SLM 9. Moreover, if the image size of the image sensor 27 is larger, the need will be lightened for the image sensor control unit 28 to move the image sensor 27 to a given position with high precision.

The filter 29 filters the modulated image data in analog quantity supplied from the image sensor 27 to enhance the separability of the binarization process by a decoder 30. That is, the captured image pattern loaded into the image sensor 27 may have a degraded separability between the light and dark spots as compared with the two-dimensional gray image pattern set in the SLM 9 due, for example, to noise to which the data and playback beams are subjected. In this case, the decoder 30 cannot properly determine whether the modulated image data in analog quantity is at the level representing the light or dark spot. This leads to an inappropriate binarization process. For this reason, the filter 29 corrects the level of the modulated image data in analog quantity as its filtering process.

It is to be noted that a binarization process unit (not shown) is provided between the filter 29 and the decoder 30 to proceed with the binarization process on the modulated image data filtered by the filter29 in the present embodiment. Then, the binarized modulated image data in digital quantity is supplied to the decoder 30.

The decoder 30 carries out the decoding process such as error correction on the modulated image data from the filter 29.

The detector 23 receives the servo laser beam emitted from the servo laser device 19 after the irradiation of the beam onto the pit representing the address information formed on the hologram recording medium 22. The detector 23 is, for example, made up of a four-part photodiode to send the light intensity information of the servo laser beam detected by the four-part photodiode to the disk control unit 24. The detector 23 also sends the address information to the CPU 1 based on the servo laser beam irradiated onto the pit representing the address information.

The disk control unit 24 servo-controls a disk drive unit 25 based on the light intensity information of the servo laser beam from the detector 23. The disk control unit 24 also sends an instruction signal to the disk drive unit 25 to rotate the hologram recording medium 22 during the playback or recording so as to irradiate the servo laser beam onto the pit representing the desired address information of the hologram recording medium 22 based on the instruction signal from the CPU 1. The disk control unit 24 also sends an instruction signal to the disk drive unit 25 to rotate the hologram recording medium 22 so as to allow the formation of a hologram at other position of the hologram recording medium 22 when the book is formed on the hologram recording medium 22.

A non-volatile memory is, for example, used for a memory 2. The memory 2 stores in advance the program data used by the CPU 1 to proceed with the above-described processes. The memory 2 also stores the address information from the pits formed in the hologram recording medium 22.

Here, if a semiconductor laser is used as the laser device 10 in the hologram apparatus, the laser device 10 is equivalent to the semiconductor laser unit 50 illustrated in FIG. 1 or FIG. 5. Therefore, the laser device 10 is a unit integrating the semiconductor laser element 100, the heater 109 and, as necessary, the thermistor 110, in a single housing as illustrated in FIG. 1 or 5. Further, when the heat generation controller according to the present invention is configured with analog circuitry as a peripheral circuit of the laser device 10, the components (101, 102, 103, 104, 105, 106, 107, 108) illustrated in FIG. 1 are provided. On the other hand, when the heat generation controller according to the present invention is configured with digital circuitry as a peripheral circuit of the laser device 10, the components (101, 102, 103, 104, 108, 200, 204, 205, 206) illustrated in FIG. 5 are provided.

As described above, the stabilization of the laser beam wavelength can be readily realized in the hologram apparatus required to ensure high accuracy in control.

While embodiments of the present invention have been described, it should be understood that the aforementioned embodiments are intended for easy understanding of the present invention and not intended for restrictive interpretation of the invention. The present invention can be changed or modified without departing from the essence thereof and includes the equivalents thereof.

What is claimed is:

1. A semiconductor laser device with a semiconductor laser element operable to oscillate and output a laser beam, the semiconductor laser device comprising:
a heat generator that generates heat so as to regulate the temperature of the semiconductor laser element;
a laser beam splitter that splits a laser beam, oscillated and output from the semiconductor laser element, into first and second beams each forming an optical path different from each other; and
a heat generation controller that controls the amount of heat generated by the heat generator so as to maintain constant a fringe spacing between interference fringes with a plurality of fringes obtained as a result of the interference between the first and second beams.

2. The semiconductor laser device of claim 1, wherein
the laser beam splitter has a beam splitter that receives the laser beam, emitted from the semiconductor laser element toward the laser beam emission direction and split the beam into main and auxiliary beams, and splits the auxiliary beam into the first and second beams.

3. The semiconductor laser device of claim 1, wherein
the laser beam splitter splits the laser beam, emitted from the semiconductor laser element in the direction opposite to that of the laser beam emission, into the first and second beams.

4. The semiconductor laser device of claim 1, wherein
the laser beam splitter has a shear plate whose one surface and the other opposite thereto are each provided with a slope, wherein
the laser beam splitter uses, as the first beam, a reflected beam from the one surface obtained as a result of the applying of the laser beam on the one surface, and wherein
the laser beam splitter uses, as the second beam, a reflected beam from the other surface obtained as a result of the applying of the laser beam on the other surface after the transmission through the one surface.

5. The semiconductor laser device of claim 1, wherein
at least two light receiving elements are provided to detect at least two among the plurality of the interference fringes, and wherein
a fringe spacing detector that detects, based on a detection signal having a period corresponding to the spacing between the disposed light receiving elements and combining the light reception levels of the light receiving elements, the fringe spacing.

6. The semiconductor laser device of claim 5, wherein
the fringe spacing detector is a line CCD (Charge Coupled Device) having the light receiving elements disposed vertically to the formation direction of the interference fringes and in a line, and wherein
the line CCD receives the interference fringes, formed by the first and second beams, with the light receiving elements and generates the detection signal in sine wave form according to a given clock signal supplied thereto.

7. The semiconductor laser device of claim 6, wherein
the line CCD has at least the two light receiving elements so as to satisfy the Nyquist condition.

8. The semiconductor laser device of claim 7, wherein
the line CCD has as many of the light receiving elements as required to allow for the detection of a distance twice as much as the fringe spacing.

9. The semiconductor laser device of claim 8, wherein
the number of the light receiving elements in the line CCD is determined based on a distance twice as much as the fringe spacing and a resolution of the line CCD required to detect a distance twice as much as the fringe spacing.

10. The semiconductor laser device of claim 5, wherein
the heat generation controller controls the amount of heat generated by the heat generator to ensure that the light reception levels of at least the two light receiving elements, disposed so as to be opposed to the fringes and with a spacing equal to an integral multiple of the fringe spacing, match each other.

11. The semiconductor laser device of claim 5, wherein
the heat generation controller controls the amount of heat generated by the heat generator correspondingly with the difference between a detection wavelength of the laser beam, determined by the detected fringe spacing, and a preset reference wavelength of the laser beam.

12. The semiconductor laser device of claim 5, wherein
the heat generation controller includes:
a frequency-voltage converter that converts the frequency of the detection signal to a voltage; and
a differential amplifier that amplifies the difference between the converted voltage and a reference voltage determined by a reference frequency corresponding to the reference wavelength, and wherein
the heat generation controller controls the amount of heat generated by the heat generator based on the output voltage of the differential amplifier.

13. The semiconductor laser device of claim 12, further comprising:
a temperature detector that detects the temperature of the semiconductor laser element, wherein
the amount of heat generated by the heat generator is determined based on the sum of the voltage corresponding to the detection temperature of the temperature detector and the output voltage of the differential amplifier, and wherein
the reference voltage is the sum of the voltage determined by the reference frequency and the voltage corresponding to a given reference temperature of the temperature detector.

14. The semiconductor laser device of claim 5, wherein
the heat generation controller includes:
an A/D converter that A/D converts the detection signal supplied from the fringe spacing detector, and
a digital signal processor that subjects the detection signal after the A/D conversion to the discrete Fourier transform process to obtain Fourier spectra and controls the amount of heat generated by the heat generator based on the result of comparison between the frequencies of the obtained Fourier spectra and the reference frequency corresponding to the reference wavelength of the laser beam.

15. The semiconductor laser device of claim 14, wherein
the digital signal processor determines whether the appearing frequencies of the obtained Fourier spectra are stable, further determines that the laser beam, oscillated and output by the semiconductor laser element, is in single mode when the appearing frequencies have been determined to be stable, and determines that the laser beam, oscillated and output by the semiconductor laser element, is in multimode if the appearing frequencies have been determined to be unstable.

16. The semiconductor laser device of claim 15, wherein
the digital signal processor exercises control so as to disable the laser beam oscillated and output by the semiconductor laser element if the laser beam, oscillated and output by the semiconductor laser element, is determined to be in multimode.

17. A hologram apparatus for causing a coherent recording reference beam and a coherent data beam, reflecting data to be recorded, to apply to a hologram recording medium to record a hologram so as to form interference fringes, comprising:
a semiconductor laser device incorporating a semiconductor laser element that is the oscillation source of the recording reference beam and the data beam,
the semiconductor laser device including:
a heat generator that generates heat so as to regulate the temperature of the semiconductor laser element;
a laser beam splitter that splits a laser beam, oscillated and output from the semiconductor laser element, into first and second beams each forming an optical path different from each other; and
a heat generation controller that controls the amount of heat generated by the heat generator so as to maintain constant a fringe spacing between interference fringes with a plurality of fringes obtained as a result of the interference between the first and second beams.

18. A hologram apparatus for playing back a hologram, formed as interference fringes as a result of causing a coherent recording reference beam and a coherent data beam, reflecting data to be recorded, to apply to a hologram recording medium, based on a diffracted light obtained as a result of causing a coherent playback reference beam to apply to the hologram recording medium at the same incidence angle as the recording reference beam, comprising:
a semiconductor laser device incorporating a semiconductor laser element that is the oscillation source of the playback reference beam,
the semiconductor laser device including:
a heat generator that generates heat so as to regulate the temperature of the semiconductor laser element;
a laser beam splitter that splits a laser beam, oscillated and output from the semiconductor laser element, into first and second beams each forming an optical path different from each other; and
a heat generation controller that controls the amount of heat generated by the heat generator so as to maintain constant a fringe spacing between interference fringes with a plurality of fringes obtained as a result of the interference between the first and second beams.
